(19) United States
(12) Patent Application Publication
(10) Pub. No.: US 2002/0063791 A1
(43) Pub. Date: May 30, 2002

(54) Hand-operated reading camera system

(76) Inventors: Linden Waterman, Boise, ID (US); Tim Waterman, Boise, ID (US)

Correspondence Address: PEDERSEN & COMPANY, PLLC, P.O. BOX 2666, BOISE, ID, 83701, US

(21) Appl. No.: 09/921,442

(22) Filed: Aug. 1, 2001

Related U.S. Application Data
(60) Provisional application No. 60/222,424, filed on Aug. 1, 2000.

(51) Int. Cl. H04N 5/225; H04N 9/47

(52) U.S. Cl. 348/358; 348/373; 348/63

(57) ABSTRACT

Embodiments of a video magnification camera system are shown and described, which include a platform which supports a camera unit and guides the camera unit during hand-operated movement of the camera iamit across or down a page of a text or across or down another object. The platform may comprise a guide plate with support and guide surfaces generally in a rectangular configuration, which supports a frame holding a video magnification camera focusing on the text or object on which the platform is placed. A central opening in the guide plate allows the camera to view the text or object, as the camera unit is slid laterally across the guide plate for viewing of the entire area of the text or object within the central opening. More than one guide plate or spacers may be stacked or otherwise attached to elevate the camera unit higher above the viewed text or object. Additionally, the camera unit preferably includes a fine-adjustment feature, which preferably comprises the threaded camera enclosure which engages the frame by a screw mount, and is thereby adapted to be raised and lowered in the camera frame by a screwing-action control.

### DESCRIPTION

This application claims priority of prior, provisional application Serial No. 60/222,424, filed Aug. 1, 2001), which is herein incorporated by this reference.

### BACKGROUND ON THE INVENTION

1. Field of the Invention

This invention relates in general to video magnification cameras which assist visually-impaired users and offer magnification for other purposes. More specifically, this invention relates to a video magnification camera which may be held over a page of printed information or other material or objects, so that the camera may focus on the page or object, and transmit a magnified image to a monitor for viewing of the image by the user.

2. Related Art

Video magnification cameras have been invented in the past to aid visually-impaired users both in reading and writing tasks and in viewing other objects. By magnifying the text or object, the user enjoys the independence and ability to see, use, or work with many books, documents, objects that he/she would otherwise be too small to deal with.

A video magnification camera freely moveable on an arm is described in U.S. Pat. No. 6,064,426 (issued to Waterman on May 16, 2000). A small video magnification camera has been available on the market, provided in a one-piece stationary frame that may be placed over a book page, The stationary frame serves to hold the camera, which is pointed downward, up above the page about 3 inches. The stationary-frame camera is hand-operated in that the user may move the stationary frame to various positions on a page of text, to magnify different parts of the text for viewing on the monitor.

Still, there is a need for an improved hand-operated video magnification camera. There is a need for such a camera system that is easier to use and that has a wide field of view and/or an easily-moveable design so that viewing a large portion of a page or moving to various locations on the page is convenient. The present invention addresses these needs.

### SUMMARY OF THE INVENTION

The invented reading camera system features a camera unit that comprises a magnifying video camera that is supported on a stand, “holder,” or “frame” above a printed page or visual objective The camera unit is used in conjunction with the a base or “platform” to facilitate smooth movement of the camera unit relative to the printed page or visual objective, and to provide other benefits. The camera unit, therefore, is preferably not supported by the user's hand, but need only be pushed laterally on the platform.

Preferably, camera unit is easily slidable on the platform in a plane perpendicular to the “viewing axis of the camera,” that is, parallel to the printed page being viewed. Preferably, the invented system includes a finely-adjustable magnification level adjustment system, which may comprise the camera unit being adapted so that the camera may be raised and lowered in the frame continuously in a range of at least several inches or in very small and reproducible increments.

Preferably, the finely-adjustable magnification level adjustment system comprises the camera being slidably mounted in the frame, to move up and down in the direction of the viewing axis to come nearer or move farther from to the text/object being viewed. Most preferably, the camera is threaded and cooperates with threads in or connected to the frame, so that, when an adjustment member is rotated, on its axis by hand, relative to the frame and camera, the camera's threaded cooperation with the threaded adjustment member causes the camera to move up or down relative to the text/object being viewed, depending on which way the adjustment member is rotated. This threaded connection and movement, which is herein also called a “precision screw-ring control system,” provides a very-firmly adjustable, accurate, and securely-held system, which is not prone to misadjustment and is easily done by a user even if his/her hands are not steady or agile.

Objects of the present invention, therefore, include giving the functionality of larger, more cumbersome, less portable low vision assistance systems, while giving facilitated lateral camera movement about a printed page or visual objective, and offering increased field of view compared to other hand-operated magnifying video camera devices. A further objective is to provide the preferred magnification-level precision screw ring control to adjust the magnification level, facilitate fine adjustments, and hold the position of the cylinder at any distance within its range of vertical adjustment. The screw ring control member is preferably accessible to users from multiple sides of the camera unit. This may be done by providing multiple control member surfaces on multiple sides of the camera unit, for equally-convenient adjustment for left-handed and right-handed users from, for example, the left side, front side, and right side. Another object is to provide a camera frame that is controlled with an on/off power switch easily reachable by the user, for example, preferably attached at the top or side surface of the generally cylindrical camera body or housing. Preferably, the on/off power switch gives an illuminated indication in the ‘on’ position.

### BRIEF DESCRIPTION OF THE DRAWINGS

FIG. 1 is a front side view of one embodiment of the invented video magnification system, with camera unit on one embodiment of a guide-plate.

FIG. 2 is a side view of one embodiment of a camera unit according to the invention.

FIG. 3 is a front view of the camera unit of FIG. 2.

FIG. 4A is a perspective view of one embodiment of a guide-plate according to the invention.

FIG. 4B is a detail, partial -view of the guide-plate of FIG. 4A.

FIG. 5A is a perspective view of one embodiment of an extended guide-plate according to the invention, for increased field of view.

FIG. 5B is a detail, partial view of the extended guide-plate of FIG. 5A.

### DETAILED DESCRIPTION OF THE INVENTION

Referring to the Figures, there are shown several, but not the only, embodiments of the invented hand-operated video magnification camera system. The Figures illustrate important features of the magnification system, namely, the camera unit 10 with camera 12 and frame 14, guide-plate 16 and extender 18. The Figures do not illustrate the video monitor, but it is understood that the electric/signal connection shown extending from the camera body/housing (camera “cylinder”) is connected and operatively cooperates with a viewing monitor and/or any other equipment necessary to allow the user to view the magnified image from the camera. One may read magnification camera prior art to understand that various camera mechanisms and viewing monitor connections may be supplied to make the instant invention work well.

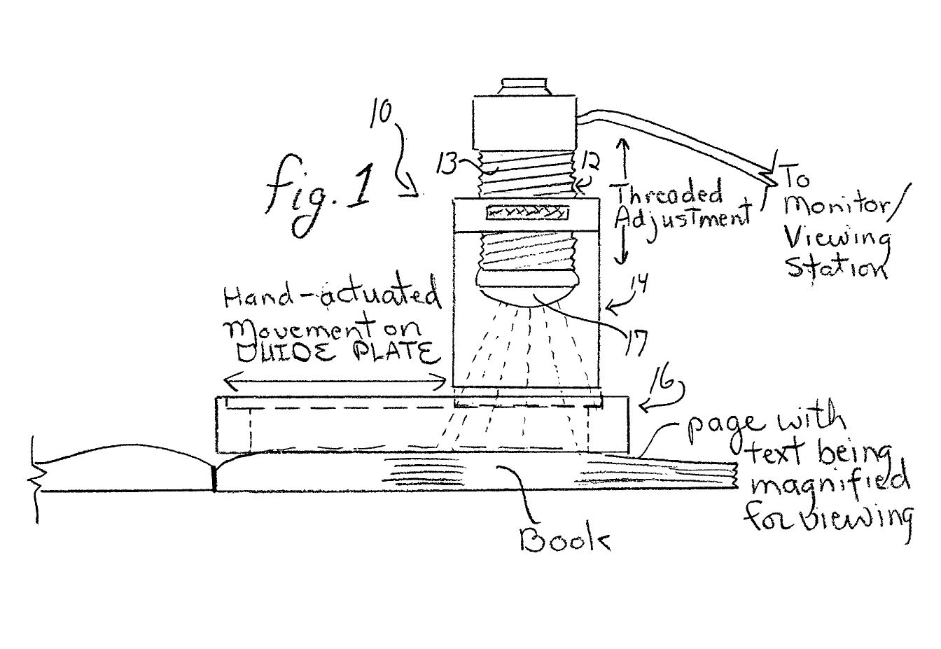

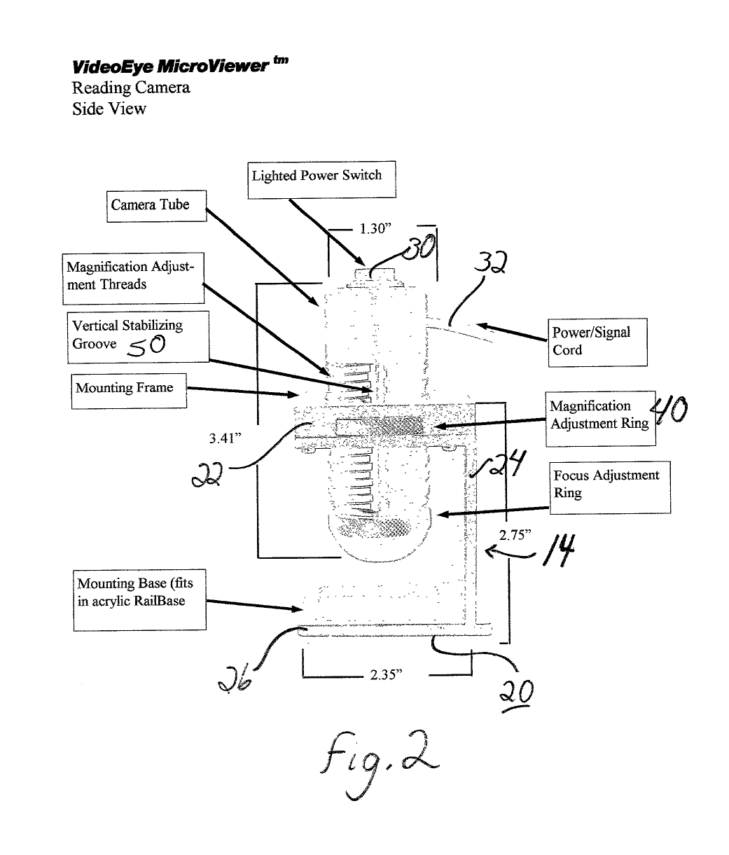

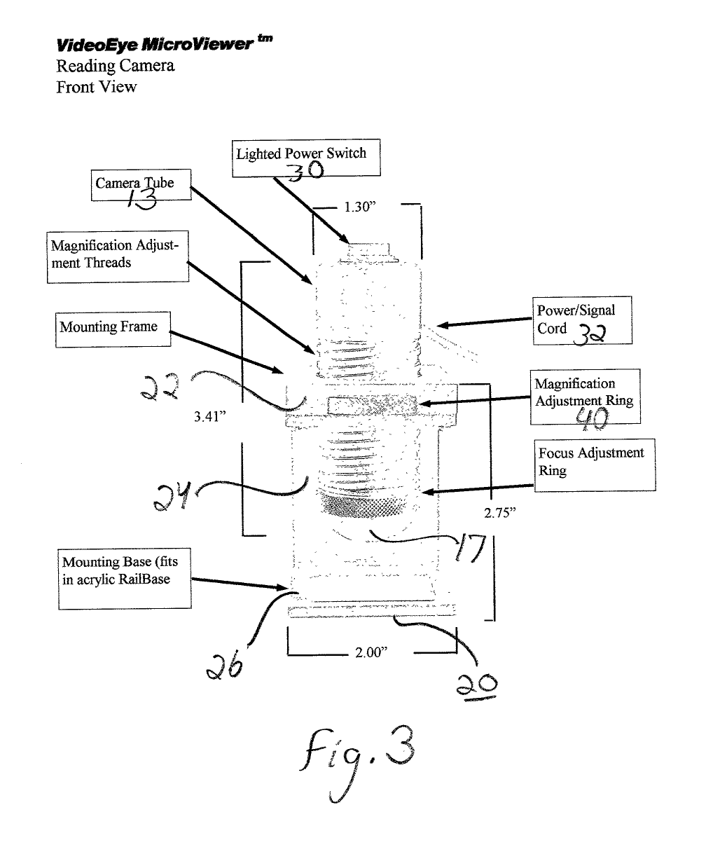

Referring especially to FIG. 1, there is shown the camera unit 10, which comprises the camera 12, which is a video magnification camera mechanism disposed within a generally cylindrical housing 13. The camera cylindrical housing 13 is positioned vertically, with the camera lenses 17 is positioned downward for focusing on a page or other object underneath the camera unit 10.

The camera cylindrical housing 13 is supported in frame 14, which elevates the camera 12 a desired distance above the bottom surface 20 of the frame 14. The frame may be generally a C-shape, with a top arm 22, a vertical arm 24, and a horizontal lower arm 26. The camera cylindrical housing 13 is preferably vertically, threadably mounted in the top arm 22 of the frame with on-off switch 30 on the top of the housing 13, power/signal cord 32 connected to the camera and extending to the monitor and/or other equipment. In other words, the camera housing is preferably vertically mounted employing a threaded mounting in the top arm, preferably transverse to the plane of the top arm and passing through generally the center of the arm. This way, the camera's longitudinal axis, herein also called the “viewing axis” is vertical, and screwing the camera housing up or down relative to the frame moves the camera lenses 17 away from or toward, respectively, the viewing objective, thus, changing the magnification and the field of view.

The up or down camera movement is preferably controlled by a “finely-tunable” or “finely-adjustable” adjustment member system, called herein a “screw ring control,” which, in the preferred embodiment, comprises adjustment ring 40. The female-threaded ring 40 threadably engages the male-threaded camera cylindrical housing 13, and the ring 40 is mounted in the top arm, so that when the ring 40 is rotated on its vertical axis, the ring rotates in the top arm, and forces the camera housing (and therefore the lense) up or down relative to the top arm.

The screw ring control with its ring 40 is mounted within the frame that supports the camera, such that as the ring 40 is rotated, it adjusts the height of the cylindrical housing which encloses the camera mechanism. The inside of the ring is threaded (preferably at a pitch of approximately 5 threads per inch, although variations of 3 to 12 threads per inch may be used in ;subsequent models), as is the cylindrical housing around which it mounts. As the ring is rotated, it causes the cylinder to move vertically with respect to the mounting frame. Two vertical grooves 50 are preferably provided 180 degrees apart on, running vertically along the side of, the threaded cylinder. These grooves 50 fit into triangular cutouts located on the stationary frame (top arm 22) of the camera frame. The grooves serve to prevent the cylinder from rotating with respect to the frame as the screw ring control is turned.

The guide-plate 16, the preferred “platform,” is a device which supports the camera unit 10 and provides other advantageous functions to the user. The camera unit rest on the guide plate while in use, but is “removably received” in that the camera unit may be easily separated from the guide plate to orient it over a new visual objective, and to make the camera unit and guide plate more portable. The guide plate is preferably formed from acrylic or other suitable material, preferably a transparent or translucent material. In its most preferred form, it is approximately seven inches long, three and one half inches wide, and one inch high. However the inventors anticipate supplying the device in other lengths, for example, lengths varying up to 16 inches long, eight inches high, and six inches wide, as may prove useful for specific individuals. The guide-plate is preferably a generally rectangular structure, preferably a four-sided-outer-perimeter-edge open frame that has an open inside area 60 through which line of sight is obtained by the camera.

The guide-plate 16 rests on the surface of a visual objective to provide stability and smooth horizontal movement of a magnifying camera by guiding the camera unit 10 in a straight path along a means for supporting and guiding the camera unit. The means for supporting and guiding may be of various designs, for example, engraved rails, tracks or channels, imbedded rails, tracks or channels, or some other means of supporting and guiding the camera unit. In the preferred system, said means comprises two spaced horizontal walls 42, 42′ that receive and support portions of the frame bottom arm and two vertical walls (guide rails 44, 44′) spaced apart slightly more than the depth of the frame bottom arm. This way the camera unit is supported above the viewing objective, increasing the field of view, while also supplying a guiding frame along which the camera unit may be smoothly moved to give more controlled, smooth, and reproducible movement for the camera unit.

The preferred embodiment of guide plate has a definite orientation with the top surface only having the support rails and guide rails accessible for receiving the frame. Optionally, but less preferably, the bottom surface of the guide plate (not shown) may be designed to also have similar support rail surfaces and guide rail surfaces as the top surface, so that the guide plate may be flipped over and used to support the frame at a slightly different elevation above the viewing objective, but to still supply smooth and predictable movement of the frame between the ends of the guide plate. In such an optional embodiment, both the top and bottom surfaces of the guide plate may have imbedded grooves or other support and guide means in which the camera unit 10 may rest and slide laterally (horizontally), so that the guide plate may be flipped over to serve as a guide plate, in effect, of a different thickness. In this optional design, the “different thickness” of the guide plate results from the two sets of support rails being differently distanced from their respective resting surfaces (the surface upon which the guide plate rests on the viewing object). In other words, flipping over the guide plate provides a second set of support and guiding surfaces at different heights relative to the resting surface (and therefore relative to the surface of the object being viewed. In this optional embodiment, allowing the guide-plate to be used either “face-up” or “face-down” yields two magnification/field-of-view ranges. By using the guide-plate while it rests on its bottom surface 70, or flipping it over to rest on its top surface 72, and placing the camera unit thereon, the guide-plate supports the magnifying camera at two distinct viewing distances from the printed page or visual objective—the lower distance which yields a higher magnification /lower field-of-view range, and the higher distance which yields a lower magnification/higher field-of-view range.

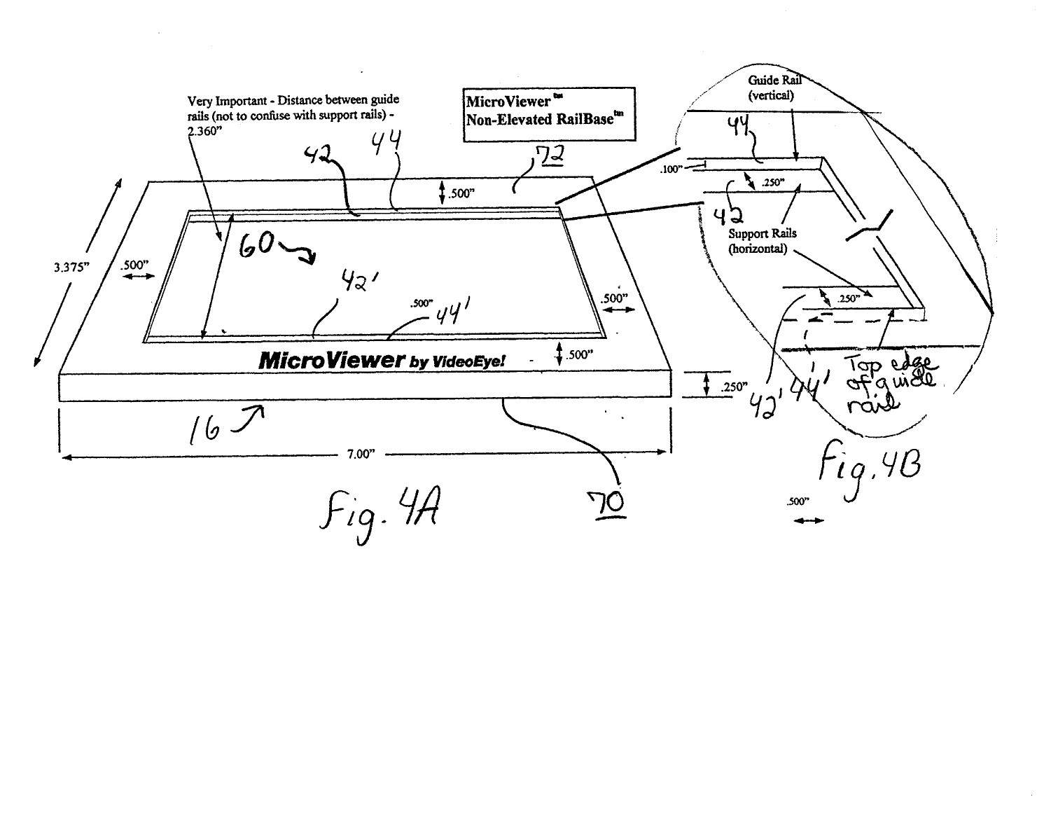

The Figures show the top surface 72 of the guide-plate with its supports rails 42, 42′ and guide-rails 44, 44′. The bottom arm of the frame is placed on the guide plate, with the bottom arm bottom surface fitting closely but smoothly-slidable between the guide rails 76, so that the frame may be slid parallel to the guide plate between the ends of the guide plate (right and left ends as shown in FIG. 4A and 4B). Preferably, for example, the bottom arm of the frame is 2.35 inches across and the guide rails are 2.36 inches apart, making an accurate but non-binding fit of the frame on the supports rails and between the guide rails.

To the inventor's knowledge, hand-movable camera viewing devices have a more restricted field of view than the present invention, even at their lowest magnification. This is due to a physical limitation of small lenses, which when designed for a focal length which would allow for the larger field of view (at this close distance), distort around the edges (an effect commonly known as “fisheye”). By raising the camera above a printed page (about 0.9 inch in the case of the 1 inch high guide plate), a non-distorting lens yields a larger field of view. This is critical, because the increased height increases the field of view of a ion-distorting 6 mm lens from 1.22 inches to 1.84 inches, sufficiently wide to view a typical 1.65 inch column of newsprint without the need to move the camera horizontally. This is an important advantage of the invented device which makes its use very beneficial for low vision users whose vision is sufficient to allow them to use the system at this magnification level. Alternative embodiments may offer additional levels and/or taler platform heights with the intention of yielding yet lower magnification/increased field-of view ranges.

In the less-preferred, optional embodiment in which the guide plate may be reversed for use of a second set of support rails and a second set of guide rails, the dimension between the guide rails would be sized similarly on both sides of the guide plate. In other words, both sets of guide rails would be about 0.01 inches farther apart than the dimension of the bottom surface of the bottom arm, to give that slight amount of clearance room for smooth, non-binding movement.

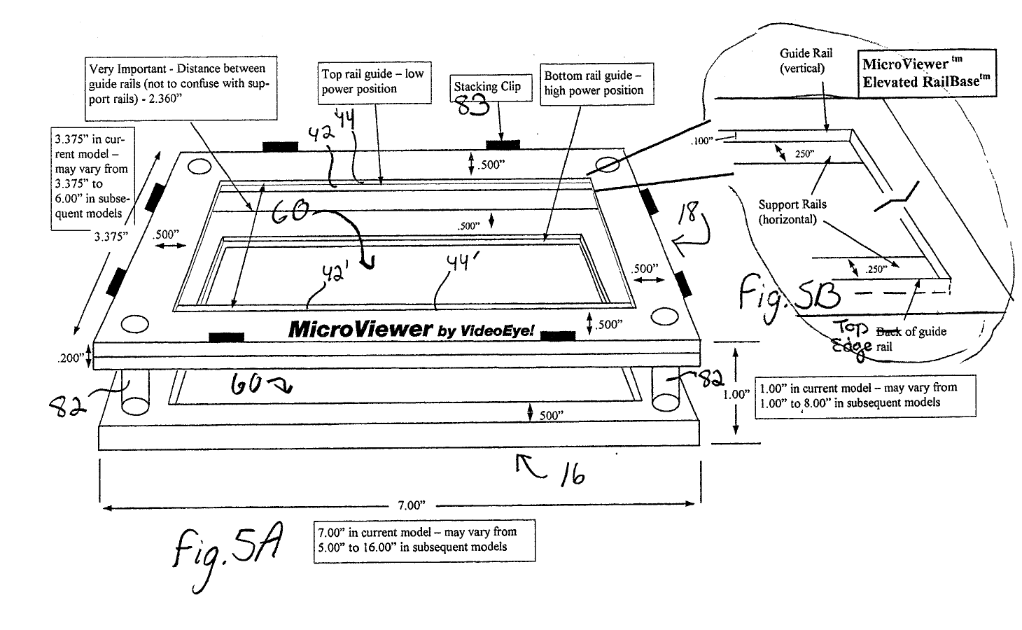

In FIG. 5A and 5B, there is shown a combination “extended” guide plate system, comprising the guide plate 16 of FIGS. 4A and 4B, plus a raised guide plate or “extender” 18 on legs or other spacing means 82. This provides even more adjustment of magnification and field of vision, by changing the elevation of the camera unit above the viewing objective. Preferably the guide plate and the raised guide plate are connected together by one or more of various means, for example, a stacking clip 83 or other connecting structure. For example, the legs 82 could securely connect by friction-fit to the lower guide plate 16. Also, additional layers of guide plate structure may be added for raising the elevation even further, for example, three guide plate structures (raised guide plate 18, guide plate 16, plus another guide plate or raised guide plate beneath, between or above the plate 18 and plate 16). In other words, one or more identical or different guide plate (or spacing plates not necessarily having guide rails or support rails) may have connection means for stacking the plates or spacers to create a platform of adjustable height for the camera unit. The connection means may be molded clips and/or other structures or devices which allow guide plate to be attached vertically to an identical guide plate (or, alternatively, differently-shaped plate) to create a “stack” of two or more plates or spacers, which are thereby held solidly together in such a way as to effectively create a new single piece guide plate or “platform” of greater height, for the purpose of supporting the magnifying camera at yet greater distances from the printed page or visual objective while preferably retaining the other advantages outlined in this Description.

The design of the invented system provides many structural and operational advantages. The guide plate supports a magnifying camera above a printed page or visual objective so that the surface is protected from scuffing and surface damage that could result from horizontal movement of the device when the user slides it across a surface. When the camera is used to view delicate material like photographs, the surface is protected from surface abrasion that would be caused by contact with and horizontal movement directly on the delicate material. Another benefit of the guide plate is that is supports a magnifying camera above a printed page or visual objective so that the camera may be removed to leave a large open space to aid the user to orient and position the platform around the desired magnification object. Also, the invented system may be used above a printed page or visual objective formed of translucent material so that a printed page or visual objective may be viewed through the interior open space of the guide plate to aid the user to orient and position the guide plate around the desired magnification object. The invented system includes large open spaces, both in the frame and in the guide plate, to allow light to reach the viewed surface to improve the performance of the camera. The invented system provides a large flat surface area for the camera unit to rest upon, which aids in keeping the viewed material in a flat, optimum position. This is helpful to view uneven material such as printed matter along the inside spine of a book.

The bottom surface of the guide plate is designed to exhibit greater friction between the guide plate and the viewed surface than the friction of the camera unit (frame bottom arm bottom surface) against the guide plate, that is, against support rails, tracks or channels, or other support and guiding means of the guide plate. This facilitates easy lateral movement of the camera from side to side without unintentionally moving the guide plate or extended guide plate system toward or away from the user. This may be done by providing a friction-increasing material or surface on the resting surface of the guide plate.

While the guide plate is shown in the Figures to provide movement side to side (right to left and left to right in the Figures), the user will often place the long dimension of the guide plate to be parallel to the length of a page, so the user may move the camera “down a page” by sliding it on the guide plate.

Although this invention has been described above with reference to particular means, materials and embodiments, it is to be understood that the invention is not limited to these disclosed particulars, but extends instead to all equivalents within the scope of the following claims.

We claim:

1. A video magnification camera system comprising:
a video magnification camera having a longitudinal axis;
a holder having a length and receiving said camera so that the camera longitudinal axis is parallel to the holder length;
a platform for resting generally horizontally on an object to be viewed by a user, and slidably receiving the holder so that the holder is slidable laterally across the platform in a direction perpendicular to the length of the holder and the camera longitudinal axis, so that the user may move the camera over various portions of the object to be viewed.

2. The camera system as in claim 1, wherein the platform comprises a first generally horizontal support surface removably receiving the holder and a first generally vertical guide surface abutting against a portion of the holder for guiding the holder in a lateral direction as the holder slides on the first support surface.

3. The camera system as in claim 2, wherein the platform comprises a second generally horizontal support surface paced from said first support surface and removably receiving the holder, so that the holder slides laterally on both first and second support surfaces.

4. The camera system as in claim 2, wherein the platform comprises a second generally vertical guide surface spaced apart from said first vertical guide surface and abutting against a portion of the holder for guiding the holder in a lateral direction as the holder slides on the first support surface.

5. The camera system as in claim 3, wherein the platform is a generally planar guide plate with an outer perimeter edge and an interior opening defined at least in part by said first and second guide surfaces, and wherein said first support surface extends generally horizontally into the interior opening from said first or second guide surfaces.

6. The camera system as in claim 1, wherein the camera is adjustable in position relative to the holder in a direction parallel to the camera longitudinal axis by means of a threaded connection to the holder.

7. The camera system as in claim 6, wherein the threaded connection comprises the camera having an enclosure having enclosure threads, and the enclosure threads engaging a threaded mount ring, wherein the mount ring is rotatably mounted in the holder, wherein rotating the mount ring on its axis moves the camera enclosure up and down relative to the mount ring and the holder.

8. The camera system as in claim 7, wherein the enclosure has a vertical groove receiving a protrusion extending from the holder to limit rotation of the enclosure on its longitudinal axis when the mount ring is rotated.

9. The camera system as in claim 1, wherein the platform comprises support and guide means selected from the group consisting of: rails extending from the platform, channels in the platform, and tracks in the platform.

10. The camera system as in claim 1, wherein the holder distances the camera from the platform resting on the object to be viewed, to increase field of view of the camera.

11. The camera system as in claim 2, wherein the platform has a bottom resting surface and a thickness from said first support surface to said bottom resting surface, so that the holder is distanced from the object to be viewed and the holder does not contact the object to be viewed and does not slide on the object to be viewed.

12. The camera as in claim 1, wherein the platform is translucent.

13. The camera system as in claim 1, wherein the platform has a resting surface for placement on the object to be viewed, and the resting surface is adapted to frictionally grip the object being viewed.

14. The camera system as in claim 1, wherein the holder is removably received on the platform.

15. The camera system as in claim 14, wherein the holder is set on the platform and not attached to the holder.

16. A video magnification camera system comprising:
a video magnification camera having a longitudinal axis;
a holder having a length and receiving said camera so that the camera longitudinal axis is parallel to the holder length;
a platform for resting generally horizontally on an object to be viewed by a user and having an interior opening revealing the object to be viewed;
an extender plate on the platform slidably receiving the holder so that the holder is slidable laterally across the extender plate in a direction perpendicular to the length of the holder and the camera longitudinal axis, so that the user may move the camera over various portions of the object to be viewed.

17. The camera system as in claim 16, wherein the extender plate comprises an interior opening for alignment with the interior opening of the platform so that the camera field of view extends through both the extender plate interior opening and the platform interior opening.

18. The camera system as in claim 17, wherein the extender plate comprises support and guide means for supporting and guiding the holder in generally horizontal movement relative to the object to be viewed.

19. The camera system as in claim 18, wherein the platform comprises support and guide means for supporting and guiding the holder in generally horizontal movement relative to the object to be viewed, when the extender plate is removed from the platform and the holder is placed on the platform.
